(19) United States
(12) Patent Application Publication
(10) Pub. No.: US 2024/0378430 A1
(43) Pub. Date: Nov. 14, 2024

(54) METHOD AND APPARATUS FOR QUANTIZING NEURAL NETWORK PARAMETER

(71) Applicant: SAPEON KOREA INC., Seongnam-si, Gyeonggi-do (KR)

(72) Inventor: Won Jae LEE, Seoul (KR)

(21) Appl. No.: 18/293,710

(22) PCT Filed: Aug. 4, 2022
(86) PCT No.: PCT/KR2022/011585

§ 371 Date: Jan. 30, 2024

(30) Foreign Application Priority Data
Aug. 4, 2021 (KR) 10-2021-0102758

(51) Int. Cl. G06N 3/0495

(52) U.S. Cl. CPC G06N 3/0495

(57) ABSTRACT

A method and a device for quantizing parameters of a neural network are disclosed. According to one aspect of the present invention, a computer-implemented method for quantizing parameters of a neural network including batch normalization parameters, the method comprising obtaining parameters in a second layer connected to a first layer; removing at least one parameter among the parameters based on either any one of output values of the first layer or batch normalization parameters applied to the parameters; and quantizing the parameters in the second layer based on parameters that have survived the removing, is provided.

### TECHNICAL FIELD

Embodiments of the present disclosure relate to a method and apparatus for quantizing neural network parameters, and particularly, to a method and apparatus for removing some parameters of a neural network based on activation or batch normalization parameters and performing quantization using surviving parameters.

### BACKGROUND ART

The content described in this section simply provides background information regarding the present disclosure and does not constitute prior art.

As artificial intelligence (AI) technology develops, many services utilizing AI are being released. Providers who provide services using AI train AI models and provide services using the trained models. Hereinafter, description will be based on neural networks among AI models.

In order to perform tasks required for a service using a neural network, there is a large amount of computation that needs to be processed, and thus a graphics processing unit (GPU) capable of parallel computation is used. However, although graphics processing units are efficient in processing neural network operations, they have the disadvantage of being high power consumption and expensive devices. Specifically, in order to increase the accuracy of a neural network, a graphics processing unit uses 32-bit floating point (FP32). At this time, since computation using FP32 consumes high power, computation using the graphics processing unit also consumes high power.

As a device for compensating for the disadvantages of such graphics processing units, research on hardware accelerators or AI accelerators is actively underway. By using an 8-bit integer (INT8) instead of FP32, AI accelerators can reduce not only power consumption but also computational complexity compared to graphics processing units.

As a method of using a graphics processing unit and an AI accelerator together, the graphics processing unit trains a neural network in FP32, the AI accelerator converts the neural network trained in FP32 to INT8 and then uses the neural network for inference. In this manner, both the accuracy and computational speed of the neural network can be achieved.

Here, a process of converting the neural network trained in the FP32 representation system to the INT8 representation system is necessary. The process of converting high precision values into low precision values in this manner is called quantization. Parameters learned as FP32 values during the training process are mapped to INT8 values which are discrete values through quantization after training is completed and can be used for neural network inference.

Meanwhile, quantization can be classified into quantization applied to weights, which are parameters of a neural network, and quantization applied to activation which is an output of a layer.

Specifically, weights of a neural network that has been trained in FP32 have FP32 precision. After training of the neural network is completed, high-precision weights are quantized to low-precision values. This is called quantization applied to the weights of the neural network.

On the other hand, since unquantized weights have FP32 precision, activation calculated using unquantized weights also has FP32 precision. Therefore, in order for neural network operations to be performed in INT8, not only weights but also activations need to be quantized. This is called quantization applied to activations of a neural network.

FIG. 1 is a diagram illustrating quantization of a neural network.

Referring to FIG. 1, a computing device 120 generates a calibration table 130 and quantized weights 140 from data 100 and weights 110 through a plurality of steps. The plurality of steps will be described in detail in FIG. 5A.

Here, the calibration table 130 is information necessary to quantize activations of layers included in the neural network and means recording a quantization range of activation for each layer included in the neural network.

Specifically, the computing device 120 does not quantize all activations and quantizes activations within a predetermined range. At this time, determining a quantization range is called calibration, and recording the quantization range is called the calibration table 130. The quantization range also applies to quantization of weights.

Meanwhile, the quantized weight 140 are obtained by analyzing the distribution of the weights 110 received by the computing device 120 and quantizing the weights 110 based on the weight distribution.

As shown in FIG. 1, the quantized weights 140 are generally generated based on the distribution of the input weights 110. In this manner, in a case where quantization is performed based only on the distribution of the weights 110, the quantized weights 140 may include distortion due to quantization.

FIG. 2 is a diagram illustrating quantization results based on weight distribution.

Referring to FIG. 2, the left graph 200 shows a weight distribution for unquantized weights. The weight values of the left graph 200 have high precision.

Before quantization, the weights are mostly distributed around the value of 0.0. However, as in the left graph 200, there may be weights that have much larger values than other weights in the weight distribution. A computing device (not shown) may perform maximum-based quantization or clipping-based quantization from the left graph 200. The weights of the right graphs 210 and 212 have low precision.

The upper right graph 210 is the result of maximum-based quantization from the left graph 200. Specifically, the computing device performs quantization on the weights in the left graph 200 based on values of −10.0 and 10.0 which have largest sizes among the weights. Weights located at the maximum or minimum before quantization are mapped to the minimum value of −127 or the maximum of 127 in the low-precision representation range. On the other hand, all weights located near the value of 0.0 before quantization are quantized to 0.

The lower right graph 212 is the result of clipping-based quantization from the left graph 200. Specifically, the computing device obtains the mean square error based on the weight distribution in the left graph 200 and calculates a clipping boundary value based on the mean square error. The computing device performs quantization on the weights based on the clipping boundary value. Weights located at the clipping boundary value before quantization are mapped to the boundary value of the low-precision representation range. On the other hand, weights located near the value of 0.0 before quantization are mapped to 0 or a value near 0. Since the range according to the clipping boundary value is narrower than the range according to the maximum and minimum of the weights before quantization, the weights are not all mapped to 0 in clipping-based quantization. In other words, weights quantized based on clipping have higher resolution than weights quantized based on the maximum.

Nevertheless, weights quantized through maximum-based quantization and clipping-based quantization are mostly mapped to the value of 0. This becomes a factor that reduces the accuracy of the neural network. In this manner, if there is an outlier weight that has a large difference from most values among weights, the performance of the neural network deteriorates when quantization is applied.

Therefore, in quantizing weights included in a neural network, research on a method of performing quantization after removing weights corresponding to outliers is required.

### DISCLOSURE

### Technical Problem

An object of embodiments of the present disclosure is to provide a method and apparatus for quantizing neural network parameters for preventing values of quantized parameters from being distorted and reducing performance degradation of a neural network due to quantization, by removing some parameters based on outputs of layers rather than the parameter distribution of the neural network before quantization.

An object of other embodiments of the present disclosure is to provide a method and apparatus for quantizing neural network parameters for preventing values of quantized parameters from being distorted and reducing performance degradation of a neural network due to quantization by removing some parameters based on batch normalization parameters rather than the parameter distribution of the neural network before quantization.

### Technical Solution

According to one aspect of the present disclosure, a computer-implemented method for quantizing parameters of a neural network including batch normalization parameters is provided, the method comprising obtaining parameters in a second layer connected to a first layer; removing at least one parameter among the parameters based on either any one of output values of the first layer or batch normalization parameters applied to the parameters; and quantizing the parameters in the second layer based on parameters that have survived the removing.

According to other aspect of the present disclosure, a computing device is provided, the computing device comprising a memory in which instructions are stored; and at least one processor, wherein the at least one processor is configured to, by executing the instructions, obtain parameters in a second layer connected to a first layer; remove at least one parameter among the parameters based on any one of output values of the first layer or batch normalization parameters applied to the parameters; and quantize the parameters in the second layer based on parameters that have survived the removing.

### ADVANTAGEOUS EFFECT

According to an embodiment of the present disclosure described above, it is possible to prevent values of quantized parameters from being distorted and reduce performance degradation of a neural network due to quantization by removing some parameters based on outputs of layers rather than the parameter distribution of the neural network before quantization.

According to another embodiment of the present disclosure, it is possible to prevent values of quantized parameters from being distorted and reduce performance degradation of a neural network due to quantization by removing some parameters based on batch normalization parameters rather than the parameter distribution of the neural network before quantization.

### BRIEF DESCRIPTION OF THE DRAWING

FIG. 1 is a diagram illustrating quantization of a neural network.

FIG. 2 is a diagram illustrating quantization results based on a weight distribution.

FIGS. 3A and 3B are diagrams illustrating quantization based on a weight distribution including outliers.

FIG. 4 is a diagram illustrating quantization according to an embodiment of the present disclosure.

FIGS. 5A and 5B are diagrams illustrating quantization of a neural network according to an embodiment of the present disclosure.

FIG. 6 is a diagram illustrating quantization results based on activation according to an embodiment of the present disclosure.

FIG. 7 is a configuration diagram of a computing device for quantization according to an embodiment of the present disclosure.

FIG. 8 is a flowchart illustrating a quantization method according to an embodiment

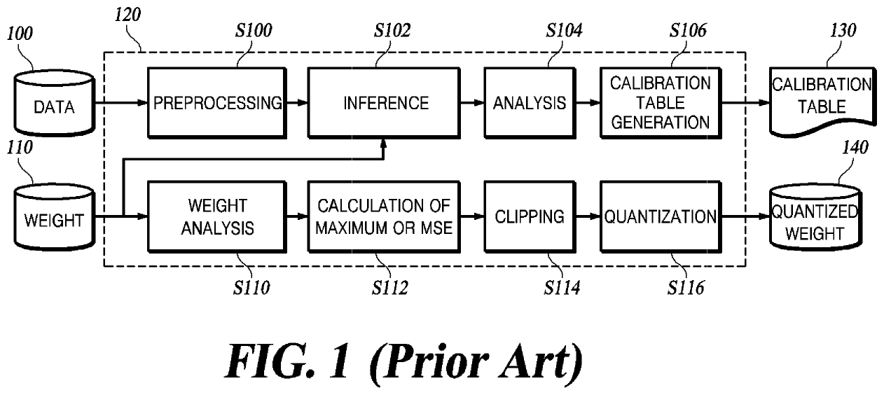

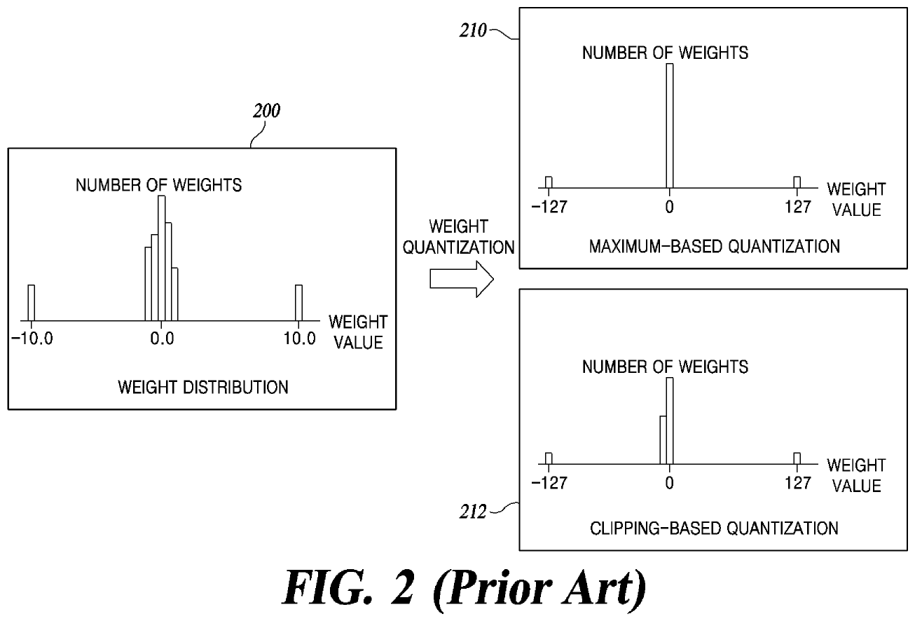

of the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

In the following, a neural network has a structure in which nodes representing artificial neurons are connected through synapses. Nodes can process signals received through synapses and transmit the processed signals to other nodes.

Neural networks can be trained based on data from various domains, such as text, audio, or video. Additionally, neural networks can be used for inference based on data from various domains.

A neural network includes multiple layers. The neural network may include an input layer, a hidden layer, and an output layer. Additionally, the neural network may further include a batch normalization layer in a training process. Batch normalization parameters in the batch normalization layer are learned along with parameters included in the layers, and have fixed values after learning is completed.

Among a plurality of layers included in the neural network, adjacent layers receive and transmit input and output. That is, the output of the first layer serves as the input of the second layer, and the output of the second layer serves as the input of the third layer. Layers exchange input and output through at least one channel. A channel can be used interchangeably with a neuron or a node. Each layer performs an operation on the input and outputs the operation result.

Here, the input and output of each channel of a layer may be referred to as input activation and output activation. In other words, activation can correspond to the output of one channel and the input of channels included in the next layer. Meanwhile, in the present disclosure, a tensor includes at least one of a weight, a bias, and an activation.

In the present disclosure, a neural network corresponds to an example of an AI model. A neural network may be implemented as a variety of neural networks, such as an artificial neural network, a deep neural network, a convolutional neural network, or a recurrent neural network. The neural network according to an embodiment of the present disclosure may be a convolutional neural network.

In the present disclosure, a neural network parameter may be used interchangeably with at least one of a weight, a bias, and a filter parameter. Additionally, the output or output value of a layer can be used interchangeably with activation. Additionally, applying a parameter to an input or an output means that an operation is performed based on the input or the output and a parameter.

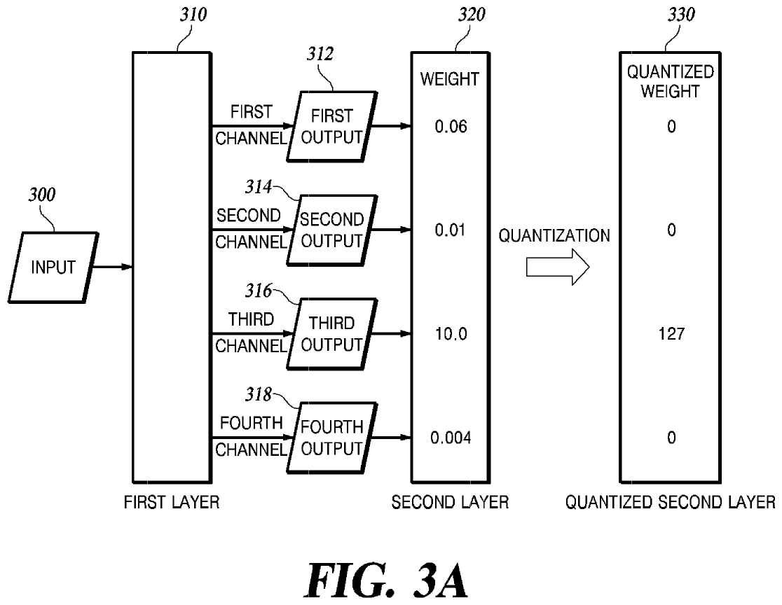

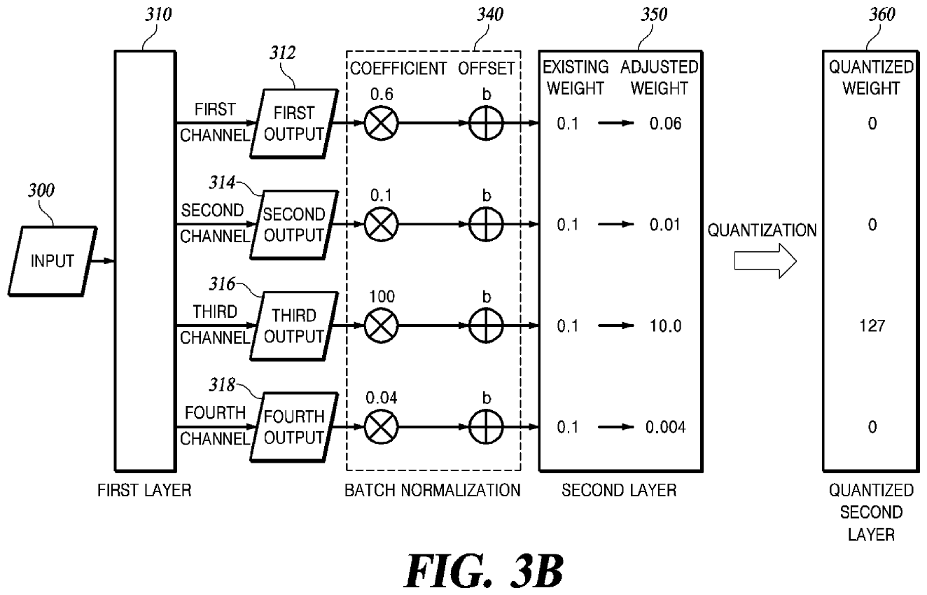

FIGS. 3A and 3B are diagrams illustrating quantization based on a weight distribution including outliers.

Referring to FIG. 3A, an input 300, a first layer 310, a plurality of channels, a plurality of outputs, a second layer 320, and a quantized second layer 330 are shown. Since the first layer 310 and the second layer 320 are examples of a neural network, the neural network may be configured to include various layer structures and various weights. Additionally, the neural network may include various channels.

The neural network includes the first layer 310 and the second layer 320, and each of the first layer 310 and the second layer 320 may include a plurality of weights.

FIG. 3A shows that one weight of the second layer 320 is applied to one output of the first layer 310, which simplifies the calculation process. Meanwhile, each weight has been learned and is a fixed value.

The first layer 310 may generate a plurality of outputs by applying weights thereof to the input 300. The first layer 310 outputs the generated outputs through at least one channel. Since the first layer 310 has four channels, the first layer 310 generates and outputs four outputs. The first output 312 is output through the first channel, and the second output 314 is output through the second channel.

For example, if the neural network is a convolutional neural network, weights may be implemented in the form of kernels in the first layer 310, and the number of kernels is the product of the number of input channels and the number of output channels. A convolution operation is performed on the kernels of the first layer 310 and the input 300 to generate a plurality of outputs.

The first output 312, second output 314, third output 316, and fourth output 318 output from the first layer 310 are input to the second layer 320.

The second layer 320 may generate an output by applying weights thereof to the first output 312, the second output 314, the third output 316, and the fourth output 318.

Here, the second layer 320 may have been trained to include weights corresponding to outliers during the training process. Hereinafter, outliers are weights that reduce the accuracy of a neural network among weights and may mean weights with large values and small numbers.

For example, in FIG. 3A, the second layer 320 includes a first weight, a second weight, a third weight, and a fourth weight. The first weight has a value of 0.06, the second weight has a value of 0.01, the third weight has a value of 10.0, and the fourth weight has a value of 0.004.

Here, the first weight, second weight, and fourth weight have values close to 0, but the third weight has a much larger value than the other weights, and thus the third weight may be an outlier.

Here, even though the second layer 320 includes an outlier, when a quantization apparatus (not shown) quantizes the weights based on the weight distribution of the second layer 320, the quantized weights of the second layer 330 may be distorted.

Specifically, the quantization apparatus may generate the quantized second layer 330 by performing maximum-based quantization or clipping-based quantization. Here, the weights of the second layer 320, which are represented as decimals and have high precision, are quantized into INT8 which has low precision after quantization.

The third weight, which has a relatively large value before quantization, has a large value even after quantization. On the other hand, weights with values close to 0, such as the first weight, second weight, and fourth weight, are all mapped to 0 through quantization. Weights that were distinguished before quantization are all mapped to the same value after quantization, and thus they are indistinguishable. When distortion occurs in the weights of the quantized second layer 330 in this manner, the accuracy of the neural network including the quantized second layer 330 deteriorates.

In summary, if quantization is performed based on a parameter distribution even though the neural network includes parameters corresponding to outliers, the accuracy of the neural network may deteriorate.

Meanwhile, referring to FIG. 3B, the neural network can perform batch normalization using batch normalization parameters 340.

Here, batch normalization is normalizing output values of a layer using each average and each variance for each channel of each mini batch including training data. Since layers within the neural network have different input data distributions, batch normalization is used to adjust input data distributions. At the time of using batch normalization, the training speed of the neural network increases.

The neural network includes a batch normalization layer in the training process, and the batch normalization layer includes batch normalization parameters. The batch normalization parameters include at least one of a mean, a variance, a scale, and a shift.

The batch normalization parameters are learned along with parameters included in other layers during the training process of the neural network. The batch normalization parameters are used to normalize the parameters of other layers as represented by Formula 1.

$$\hat{x} = α ( \frac{x - m}{V} ) + β \qquad [ Formula 1 ]$$

In Formula 1, \hat{χ} is a normalized output value, x is an unnormalized output value, α is a scale, m is the average of output values of the previous layer, V is the variance of the output values of the previous layer, and β is a shift.

A trained neural network has learned batch normalization parameters. That is, the batch normalization parameters included in the trained neural network have fixed values. The trained neural network can normalize the output of the previous layer by applying batch normalization parameters to input data.

In the trained neural network, the batch normalization parameters 340 can be directly applied to the outputs of the first layer 310, which is the previous layer, but are generally implemented as being applied to the weights of the second layer 350. Application of the batch normalization parameters 340 to the weights of the second layer 350 means that the weights of the second layer 350 are adjusted based on the batch normalization parameters 340. Specifically, at least one of the learned mean, variance, scale, and shift is used to adjust the weights of the second layer 350 in the form of y=ax+b. Here, y is an adjusted weight, x is a weight before adjustment, a is a coefficient, and b is an offset. The outputs of the first layer 310 and the adjusted weights of the second layer 350 are calculated.

However, in any case, the neural network may be trained such that the batch normalization parameters have outliers during the training process of the neural network.

Specifically, the batch normalization parameters 340 include a first coefficient, a second coefficient, a third coefficient, and a fourth coefficient. The first coefficient has a value of 0.6, the second coefficient has a value of 0.1, the third coefficient has a value of 100, and the fourth coefficient has a value of 0.04.

Here, the first coefficient, second coefficient, and fourth coefficient have small values, but the third coefficient has a much larger value than the remaining coefficients.

Weights included in the second layer 350 are adjusted based on the batch normalization parameters 340 including outliers. For example, the first weight has a value of 0.1, but it has a value of 0.06 after adjustment. The third weight has a value of 0.1, but it has a value of 10.0 after adjustment.

In this manner, even if the second layer 350 does not include outliers among the weights before being adjusted according to the batch normalization parameters 340, the second layer 350 may include a weight corresponding to an outlier after the batch normalization parameters 340 are applied.

In a case where the quantization apparatus quantizes the weights based on the weight distribution of the second layer 350 even though the second layer 350 includes an outlier after adjustment, the quantized weights of the second layer 360 can be distorted.

In a case where distortion occurs in the weights of the quantized second layer 360 in this manner, the accuracy of the neural network including the quantized second layer 360 also deteriorates.

As shown in FIGS. 3A and 3B, if the quantization apparatus performs quantization based on a parameter distribution including outliers even though the neural network is trained to include parameters corresponding to outliers or batch normalization parameters, distortion of the weights occurs.

The reason why the neural network is trained such that batch normalization parameters 340 include outliers is because the weight value of the first layer 310 corresponding to the third channel is learned to be small. If the weight value of the first layer 310 is small, the third output 316 output through the third channel also has a small value. In order to normalize or compensate for the value of the third output 316, the third coefficient applied to the third output 316 among the batch normalization parameters 340 is learned to have a large value. Accordingly, the third weight adjusted by the third coefficient also has a large value and becomes an outlier that reduces the accuracy of the neural network during the quantization process.

A quantization method according to an embodiment of the present disclosure detects a parameter corresponding to an outlier based on the output of the previous layer in consideration of a situation in which the outlier occurs in batch normalization parameters of a neural network, and removes the parameter, thereby reducing distortion of quantization.

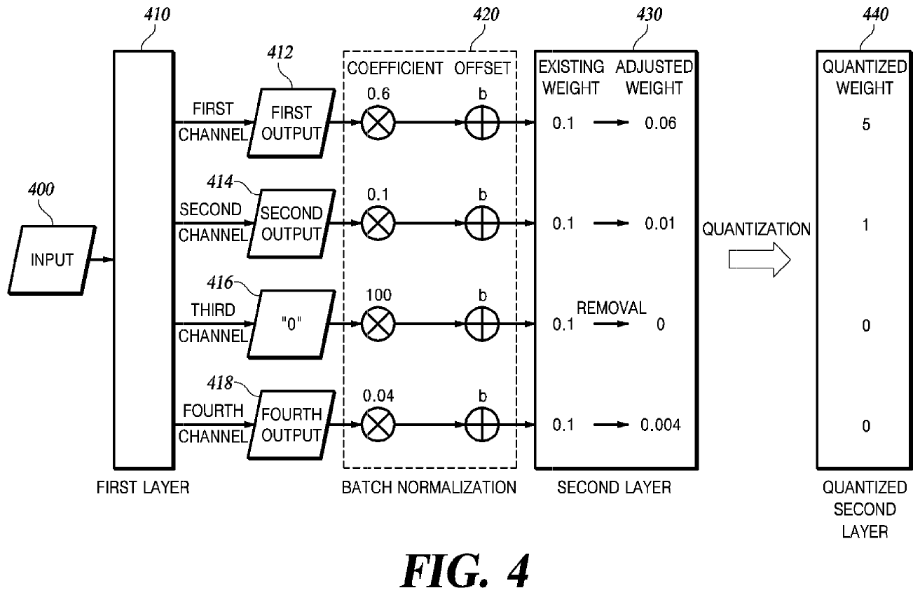

FIG. 4 is a diagram illustrating quantization according to an embodiment of the present disclosure.

A quantization apparatus (not shown) according to an embodiment of the present disclosure determines and removes parameters corresponding to outliers among parameters of the current layer based on output values of the previous layer in a neural network to which batch normalization is applied, and quantizes all parameters based on the surviving parameters.

Referring to FIG. 4, a first layer 410 and a second layer 430 are connected with batch normalization parameters 420 provided therebetween. The first layer 410 applies weights to an input 400 and outputs a plurality of outputs. The second layer 430 receives the plurality of outputs from the first layer 410.

The quantization apparatus according to an embodiment of the present disclosure acquires weights of the second layer 430 to be quantized. Here, the weight refers to existing weight that has not been adjusted.

The quantization apparatus determines a weight corresponding to an outlier among the weights included in the second layer 430 based on the output values of the first layer 410 and/or the batch normalization parameters applied to the parameters and removes the weight.

According to an embodiment of the present disclosure, the quantization apparatus identifies a channel that outputs all output values as zero among the output channels of the first layer 410. In FIG. 4, since the third output 416 output through the third channel of the first layer 410 outputs zero, the quantization apparatus identifies the third channel.

Thereafter, the quantization apparatus determines a weight associated with the third output 416 output through the identified third channel among the weights included in the second layer 430 as an outlier. The weight associated with the third output 416 refers to a weight applied to the third output 416 to generate the output of the second layer 430. In FIG. 4, the third weight is determined as an outlier.

The quantization apparatus removes the third weight. Here, removal of the third weight by the quantization apparatus may mean setting the value of the third weight to zero or a value close to zero. Alternatively, removal of the third weight may mean deleting the variable of the third weight.

Finally, the quantization apparatus quantizes the weights included in the second layer 430 based on the weights that have not been removed from the second layer 430.

Since outliers among the weights included in the second layer 430 have been removed, distortion of the weights can be reduced even if the quantization apparatus applies maximum-based quantization or clipping-based quantization to the weights of the second layer 430. That is, most weights that are distinguished from each other in the second layer 440 before quantization have distinguishable values even after quantization.

Furthermore, since the third output 416 output through the third channel is zero, even if the quantization apparatus removes the third weight, the output of the second layer 430 and subsequent operations are not affected. Even if the quantization apparatus removes the third weight, the accuracy of the neural network is not reduced.

According to another embodiment of the present disclosure, the quantization apparatus may identify a channel in which the number of non-zero values is less than a preset number among the output channels of the first layer 410, and determine a weight associated with output values output through the identified channel as an outlier.

For example, if the number of non-zero values among the output values included in the third output 416 in FIG. 4 is less than a preset number, the quantization apparatus may designate the third channel. The quantization apparatus determines the third weight applied to the third output 416 output through the third channel as an outlier. Thereafter, the quantization apparatus removes the third weight and quantizes the weights included in the second layer 430 based on the surviving weights.

Since the value of the third output 416 output through the third channel is close to 0, the performance of the neural network can be maintained even if the third weight is removed. Additionally, distortion of weights during the quantization process can be reduced.

According to another embodiment of the present disclosure, the quantization apparatus may identify a channel in which the number of output values less than a preset value is less than a preset number among the output channels of the first layer 410, and determine a weight associated with output values output through the identified channel as an outlier.

For example, if the number of output values less than the preset value among the output values included in the third output 416 is less than the preset number, the quantization apparatus may designate the third channel. The quantization apparatus determines the third weight applied to the third output 416 output through the third channel as an outlier. Thereafter, the quantization apparatus removes the third weight and quantizes the weights included in the second layer 430 based on the surviving weights. Here, the preset value and the preset number may be arbitrarily determined.

According to another embodiment of the present disclosure, the quantization apparatus may select an outlier from among the weights included in the second layer 430 using the batch normalization parameters 420. Here, the batch normalization parameters 420 are applied to the weights of the second layer 430 to adjust the values of the weights of the second layer 430.

Specifically, the quantization apparatus identifies a batch normalization parameter that satisfies a preset condition among the batch normalization parameters 420. Here, the preset condition is having a value greater than a preset value. That is, the quantization apparatus can identify a batch normalization parameter that has a value greater than the preset value among the batch normalization parameters 420. For example, when the preset value is 10, the quantization apparatus can identify the third coefficient having a value of 100.

Next, the quantization apparatus determines a weight associated with the identified batch normalization parameter among the weights included in the second layer 430 as an outlier. A weight associated with an identified batch normalization parameter or a weight applied to the identified batch normalization parameter means a weight to be adjusted by the identified batch normalization parameter. In FIG. 4, the third weight adjusted by the third coefficient is determined as an outlier.

The quantization apparatus removes the third weight and quantizes the weights included in the second layer 430 based on the weights that are not removed from the second layer 430. Even in this case, the quantization apparatus can reduce distortion of the weights during the quantization process and prevent reduction in the accuracy of the neural network by removing the weight corresponding to the outlier.

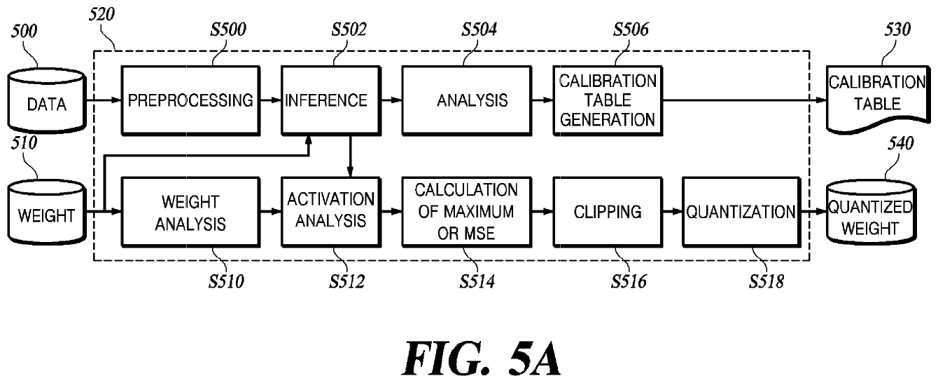

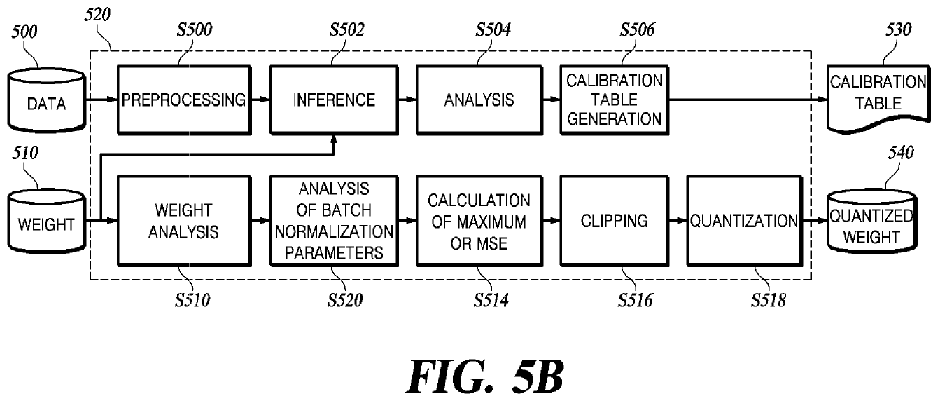

FIGS. 5A and 5B are diagrams illustrating quantization of a neural network according to an embodiment of the present disclosure.

Referring to FIGS. 5A and 5B, a computing device 520 according to an embodiment of the present disclosure generates a calibration table 530 and quantized weights 540 from data 500 and weights 510 through a plurality of steps. Here, the computing device 520 includes a quantization apparatus according to an embodiment of the present disclosure.

Specifically, the computing device 520 loads the data 500 and the weights 510.

To generate the calibration table 530, the computing device 520 preprocesses the input data 500 into data to be input to a neural network (S500).

The computing device 520 may process the data 500 into more useful data by removing noise from the data 500 or extracting features therefrom.

The computing device 520 performs inference using the preprocessed data and the weights 510 (S502).

The computing device 520 may perform a task of the neural network through inference.

Thereafter, the computing device 520 analyzes the results of inference (S504).

Here, the result of inference is obtained by analyzing activations generated in the inference step.

The computing device 520 generates the calibration table 530 according to the result of inference (S506).

In order to quantize the weights 510, the computing device 520 analyzes weight distribution from the input weights 510 (S510).

Referring to FIG. 5A, the computing device 520 analyzes activations produced in the inference process S502 (S512).

According to an embodiment of the present disclosure, the computing device 520 identifies channels that output activations having a value of 0 in each layer to which batch normalization is applied, and removes a weight applied to output values output through the identified channels.

According to another embodiment of the present disclosure, the computing device 520 identifies channels in which the number of nonzero output values is less than a preset number in each layer to which batch normalization is applied, and removes a weight applied to output values output through identified channels.

Referring to FIG. 5B, the computing device 520 according to another embodiment of the present disclosure analyzes batch normalization parameters (S520).

The computing device 520 identifies batch normalization parameters that meet preset conditions among the batch normalization parameters and removes a weight to be adjusted by the batch normalization parameters.

Referring to FIGS. 5A and 5B, after adjusting the values of some weights to 0 according to embodiments of the present disclosure, the computing device 520 calculates a maximum or a mean square error (MSE) based on the surviving weight (S514).

The computing device 520 determines a quantization range from the maximum or mean square error of the weights 510 and clips the weights 510 according to the quantization range (S514).

The computing device 520 quantizes the weights 510 after performing clipping (S516).

Through each process, the computing device 520 generates the calibration table 530 and the quantized weights 540. Here, the quantized weights 540 have lower precision than the weights 510 that are not quantized.

The computing device 520 may directly use the calibration table 530 and the quantized weights 540, or may transmit the calibration table 530 and the quantized weights 540 to an AI accelerator. The AI accelerator can perform operations of the neural network with low power without performance deterioration using the calibration table 530 and the quantized weights 540.

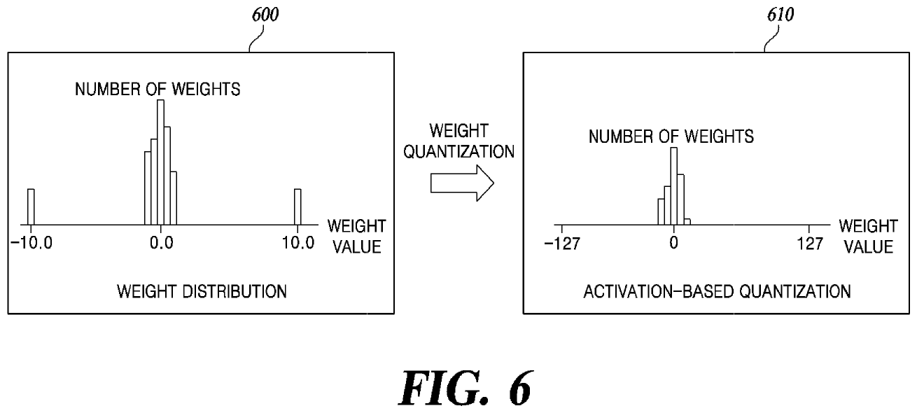

FIG. 6 is a diagram illustrating results of quantization based on activation according to an embodiment of the present disclosure.

Referring to FIG. 6, a weight distribution of weights that are not quantized is shown in the left graph 600. The weights of the left graph 600 have high precision.

Most weights before quantization are distributed near the value of 0.0. However, as shown in the left graph 600, weights much greater than other weights may be present in the weight distribution. Here, the computing device (not shown) according to an embodiment of the present disclosure performs activation-based quantization from the left graph 600. According to quantization, the weights of the right graph 610 have low precision.

The right graph 610 shows a result of activation-based quantization from the left graph 600. Specifically, the computing device removes at least one of weights of the current layer based on outputs of the previous layer among the layers in the neural network, and quantizes weights of the current layer based on the surviving weights. In the left graph 600, −10.0 and 10.0 are determined to be outliers in the activation-based quantization process and thus removed. Since weights are quantized based on weights near 0.0 with the outliers removed from the left graph 600, the weights near 0.0 in the left graph 600 are mapped to 0 or values near 0 in the right graph 610 instead of being mapped to only 0. That is, according to activation-based quantization, the weights have high resolution after quantization.

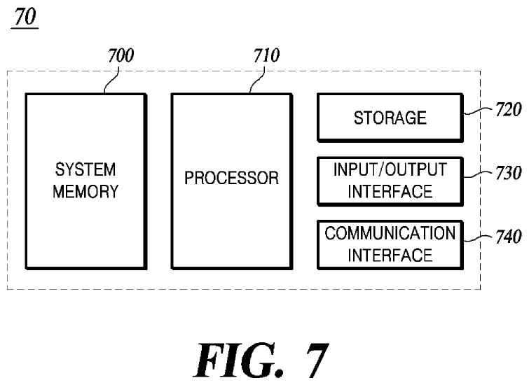

FIG. 7 is a configuration diagram of a computing device for quantization according to an embodiment of the present disclosure.

Referring to FIG. 7, the computing device 70 may include some of all of a system memory 700, a processor 710, a storage 720, an input/output interface 730, and a communication interface 740.

The system memory 700 may store a program that allows the processor 710 to perform a quantization method according to an embodiment of the present disclosure. For example, the program may include a plurality of instructions executable by the processor 710, and a quantization range of an artificial neural network can be determined by the processor 710 executing the plurality of instructions.

The system memory 700 may include at least one of a volatile memory and a nonvolatile memory. The volatile memory includes a static random access memory (SRAM) or a dynamic random access memory (DRAM), and the nonvolatile memory includes a flash memory.

The processor 710 may include at least one core that can execute at least one instruction. The processor 710 can execute the instructions stored in the system memory 700 and perform a method of determining a quantization range of an artificial neural network by executing the instructions.

The storage 720 maintains the stored data even if power supplied to the computing device 70 is blocked. For example, the storage 720 may include a nonvolatile memory such as an electrically erasable programmable read-only memory (EEPROM), a flash memory, a phase change random access memory (PRAM), a resistance random access memory (RRAM), or a nano floating gate memory (NFGM), or may include storage media such as a magnetic tape, an optical disc, and a magnetic disk. In some embodiments, the storage 720 may be removed from the computing device 70.

According to an embodiment of the present disclosure, the storage 720 may store a program for performing quantization on parameters of a neural network including a plurality of layers. The program stored in the storage 720 may be loaded to the system memory 700 before the program is executed by the processor 710. The storage 720 may store files written in a program language, and a program generated from a file by a compiler or the like may be loaded to the system memory 700.

The storage 720 may store data to be processed by the processor 710 and data processed by the processor 710.

The input/output interface 730 may include an input device such as a keyboard, a mouse, and the like, and may include an output device such as a display device and a printer.

A user may trigger execution of the program by the processor 710 through the input/output interface 730. In addition, the user may set a target saturation rate through the input/output interface 730.

The communication interface 740 provides access to an external network. For example, the computing device 70 can communicate with other devices through the communication interface 740.

Meanwhile, the computing device 70 may be a mobile computing device such as a laptop computer, or a smartphone as well as a stationary computing device such as a desktop computer, a server, or an AI accelerator.

An observer and a controller included in the computing device 70 may be a procedure as a set of a plurality of instructions executed by the processor and may be stored in a memory accessible by the processor.

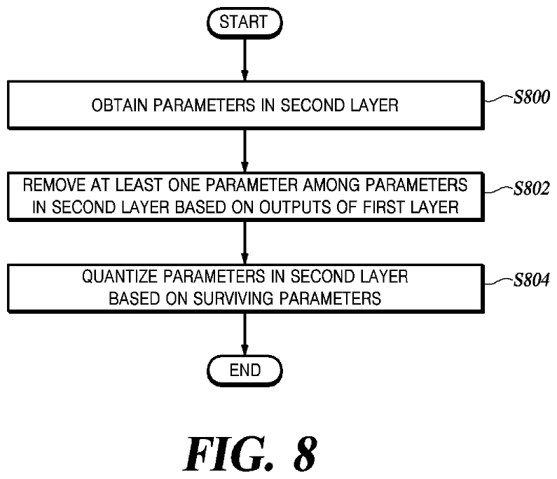

FIG. 8 is a flowchart illustrating a quantization method according to an embodiment of the present disclosure.

The quantization method according to an embodiment of the present disclosure is applied to a neural network to which batch normalization has been applied.

Referring to FIG. 8, a quantization apparatus according to an embodiment of the present disclosure obtains parameters in a second layer connected to a first layer (S800).

During neural network operations, the parameters included in the second layer are adjusted based on batch normalization parameters. An operation is performed on the adjusted parameters of the second layer and the outputs of the first layer.

The quantization apparatus removes at least one parameter based on any one of output values of the first layer output from the first layer or the batch normalization parameters applied to the parameters in the second layer (S802).

According to an embodiment of the present disclosure, the quantization apparatus identifies a channel through which output values are all output as zero among output channels of the first layer, and removes at least one parameter applied to the output value output through the identified channel among the parameters of the second layer.

According to another embodiment of the present disclosure, the quantization apparatus identifies a channel in which the number of nonzero output values is less than a preset number among output channels of the first layer and removes at least one parameter applied to output values output through the identified channel among the parameters of the second layer.

According to another embodiment of the present disclosure, the quantization apparatus identifies a channel in which the number of output values less than a preset value is less than a preset number among the output channels of the first layer and removes at least one parameter applied to output values output through the identified channel.

According to another embodiment of the present disclosure, the quantization apparatus identifies batch normalization parameters that meet preset conditions among batch normalization parameters, and removes at least one parameter associated with the identified batch normalization parameters among parameters of the second layer. Here, identifying parameters that meets the preset conditions is to identify batch normalization parameters having values greater than a preset value by the quantization apparatus among the batch normalization parameters. In addition, removal of a parameter means setting the parameter value to zero. Alternatively, removal of a parameter can mean deleting the variable of the parameter or setting the parameter value to a value near zero.

Thereafter, the quantization apparatus quantizes the parameters in the second layer based on the parameters surviving the removal process (S804).

The quantization apparatus may quantize the parameters in the second layer through maximum-based quantization, mean square error-based quantization, or clipping-based quantization.

Although FIG. 8 shows that process S800 to process S804 are sequentially performed, this is merely an example of the technical idea of an embodiment of the present disclosure. In other words, those skilled in the art can modify and apply the processes in various manners by changing the order shown in FIG. 8 or executing one or more of processes S800 to S804 in parallel without departing from the essential characteristics of an embodiment of the present disclosure, and thus FIG. 8 is not limited to a chronological order.

Meanwhile, the processes shown in FIG. 8 can be implemented as computer-readable code in a computer-readable recording medium. The computer-readable recording medium includes all kinds of recording devices that stores data readable by a computer system. That is, such computer-readable recording media include non-transitory media such as a ROM, a RAM, a CD-ROM, a magnetic tape, a floppy disk, and an optical data storage device. In addition, computer-readable record media can be distributed to computer systems connected via a network, and computer-readable code can be stored and executed in a distributed manner.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### REFERENCE NUMERALS

700: system memory
710: processor
720: storage
730: input/output interface
740: communication interface

### CROSS-REFERENCE TO RELATED APPLICATION

This application claims priority from Korean Patent Application No. 10-2021-0102758filed on August 2021, the disclosures of which are incorporated by reference herein in their entireties.

1-9. (canceled)

10. A computer-implemented method for quantizing parameters of a neural network including batch normalization parameters, the method comprising:
obtaining parameters in a second layer connected to a first layer;
removing at least one parameter among the parameters based on either any one of output values of the first layer or batch normalization parameters applied to the parameters; and
quantizing the parameters in the second layer based on parameters that have survived the removing.

11. The method according to claim 10, wherein the removing of the at least one parameter comprises:
identifying a channel that outputs all output values as zero among output channels of the first layer; and
removing at least one parameter applied to an output value output through the identified channel among the parameters.

12. The method according to claim 10, wherein the removing of the at least one parameter comprises:
identifying a channel in which the number of nonzero output values is less than a preset number among the output channels of the first layer; and
removing at least one parameter applied to output values output through the identified channel among the parameters.

13. The method according to claim 10, wherein the removing of the at least one parameter comprises:
identifying a channel in which the number of output values less than a preset value is less than a preset number among the output channels of the first layer; and
removing at least one parameter applied to output values output through the identified channel among the parameters.

14. The method according to claim 10, wherein the removing of the at least one parameter comprises setting the value of the at least one parameter to zero.

15. The method according to claim 10, wherein the removing of the at least one parameter comprises:
identifying a batch normalization parameter that satisfies preset conditions among the batch normalization parameters; and
removing at least one parameter applied to the identified batch normalization parameter among the parameters.

16. The method according to claim 15, wherein the identifying of a batch normalization parameter comprises identifying a batch normalization parameter having a value greater than a preset value among the batch normalization parameters.

17. A computing device comprising:
a memory in which instructions are stored; and
at least one processor,
wherein the at least one processor is configured to, by executing the instructions:
obtain parameters in a second layer connected to a first layer;
remove at least one parameter among the parameters based on any one of output values of the first layer or batch normalization parameters applied to the parameters; and
quantize the parameters in the second layer based on parameters that have survived the removing.

18. A computer-readable recording medium recording a computer program for executing the method of claim 10.
